(19) United States
(12) Patent Application Publication
(10) Pub. No.: US 2012/0014093 A1
(43) Pub. Date: Jan. 19, 2012

(54) CHASSIS, LIGHTING DEVICE, AND DISPLAY DEVICE

(75) Inventor: Masahiro Arai, Osaka (JP)

(73) Assignee: SHARP KABUSHIKI KAISHA, Osaka (JP)

(21) Appl. No.: 13/256,609

(22) PCT Filed: Oct. 29, 2009
(86) PCT No.: PCT/JP2009/068559

§ 371 Date: Sep. 14, 2011

(30) Foreign Application Priority Data
Mar. 23, 2009 (JP) 2009-069853

(51) Int. Cl. G09F 13/04; F21V 15/04

(52) U.S. Cl. 362/97.1; 362/390

(57) ABSTRACT

A backlight chassis 11 in which a lamp clip 21 that grips a fluorescent tube 41 is attached to a hole HL, includes an annular groove portion 12 that surrounds the hole HL.

### TECHNICAL FIELD

The present invention relates to a chassis to be incorporated in an electronic device, such as a lighting device; to a lighting device itself (such as a backlight unit, or the like) that incorporates the chassis; and to a display device (such as a liquid crystal display device) incorporating the lighting device.

### BACKGROUND ART

Normally, the liquid crystal itself within a liquid crystal display panel (display panel) does not emit light. Because of this, in a liquid crystal display device, external light, such as light from the sun, is received and this external light is used to display various images on the liquid crystal display panel. The liquid crystal display device preferably has a backlight unit (a lighting device) for lighting the liquid crystal, contemplating a case that external light is not received.

There are various different types of backlight units. For example, as illustrated in FIG. 9, there is a backlight unit 149 of the direct-light type wherein a plurality of fluorescent tubes 141 is arranged in parallel facing the back face of the liquid crystal display panel. (See Patent Document 1.)

However, in such a backlight unit 149, the fluorescent tubes 141 are held on both ends by lamp holders 142, and are held by lamp clips 121 in positions other than both ends. The fluorescent tubes 141 emit light according to an AC signal in the tens of kilohertz, provided from an inverter, not shown. Moreover, the intensity of the fluorescent tubes 141 that emit the light is adjusted through an AC signal known as the lighting control signal.

### RELATED ART DOCUMENTS

### Patent Documents

Patent Document 1: Japanese Patent Application Laid-Open Publication No. 2006-32358 (See FIG. 1.)

### SUMMARY OF THE INVENTION

### Problems to be Solved by the Invention

In the case of the backlight unit 149 illustrated in FIG. 9, a problem occurs when the backlight chassis (chassis) 111 that contains the fluorescent tubes 141 is made of metal. That problem is caused by a distributed capacitance (a parasitic capacitance) that is produced between the fluorescent tube 141 to which the AC signal is applied and the backlight chassis 111 that is made out of metal.

Specifically, the problem is as follows. Normally, an electromagnetic force is produced on the fluorescent tube 141 through the parasitic capacitance that is produced through the ON signal, which is an AC signal, and the fluorescent tube 141 that is affected by this electromagnetic force undergoes dislocation relative to the backlight chassis 111 (dislocates so as to go nearer to the backlight chassis 111). On the other hand, the parasitic capacitance vanishes when the AC signal is an OFF signal, and the fluorescent tube 141, not under the effect of this electromagnetic force, tends to return toward the original position (dislocates away from the backlight chassis 111).

That is, depending on the electromagnetic force that is produced by the AC signal and then vanishes, the fluorescent tube 141 is caused to move towards and away from the backlight chassis 111, causing a vibration in the fluorescent tube 141. Moreover, the vibration in the fluorescent tube 141 propagates also to the backlight chassis 111 through the lamp clip 121, to cause the backlight chassis 111 to vibrate. (The backlight unit 149 then vibrates.)

When the vibration of the backlight chassis 111 is caused by the lighting control signal, the vibration is synchronized with the wavelength band of the AC signal of the lighting control signal, vibrating in the order of hundreds of kilohertz through megahertz. The vibrations in this wavelength band include a band that is audible to humans. Because of this, when the intensity of a liquid crystal display incorporating the backlight unit 149 is adjusted, the user inevitably hears a discomforting noise.

The present invention is the result of contemplation on the situation set forth above. An object of the present invention is to provide a chassis that controls the diffusion of the vibration, an inherited name device that controls the vibration of the entire device through mounting on the chassis, and a display device wherein this lighting device is mounted.

### Means for Solving the Problems

A chassis includes an attaching portion for attaching a clip for gripping a light source. Moreover, the chassis includes an annular surrounding portion for surrounding the attaching portion and absorbing the vibration from the attaching portion.

When formed in this way, even if, for example, a vibration from the light source were to propagate to the chassis through the clip, the vibration would be absorbed by the surrounding portion, and would not proliferate to the entire chassis. Because of this, the noise caused by the vibration of the chassis is reduced.

Note that the surrounding portion preferably is an engraved groove on one face of the chassis. In the case of this groove, preferably the inner surface within the groove is formed of a collection of a plurality of different curved surfaces.

Moreover, the surrounding portion preferably is a ridge that is built-up from one face of the chassis. In the case of this ridge, preferably the outside surface of the ridge is formed of a collection of a plurality of different curved surfaces.

Note that a lighting device that includes the aforementioned chassis, a linear light source as a light source, and a clip for holding the linear light source is also the present invention. Furthermore, a display device that includes this lighting device and a display panel that receives light from the lighting device are also the present invention.

### Effects of the Invention

In the chassis of the present invention, the surrounding portion absorbs the vibration, so the entire chassis does not vibrate. Because of this, the noise that is caused by the chassis vibrating is reduced.

### BRIEF DESCRIPTION OF THE DRAWINGS

FIG. 1 is it a perspective assembly diagram of a liquid crystal display device.

FIG. 2 is a double view diagram showing a plan view and a cross-sectional diagram of a backlight chassis.

FIG. 3 is an expanded cross-sectional view of a backlight chassis.

FIG. 4 is a waveform diagram illustrating the high-frequency waves in the signal.

FIG. 5 is a double view diagram showing a plan view and a cross-sectional diagram of a backlight chassis.

FIG. 6 is a waveform diagram illustrating the waveform characteristics of the lighting control signal.

FIG. 7 is an expanded cross-sectional view of the backlight chassis.

FIG. 8 is a perspective diagram illustrating a lamp clip and a backlight chassis.

FIG. 9 is a perspective diagram showing a conventional backlight unit.

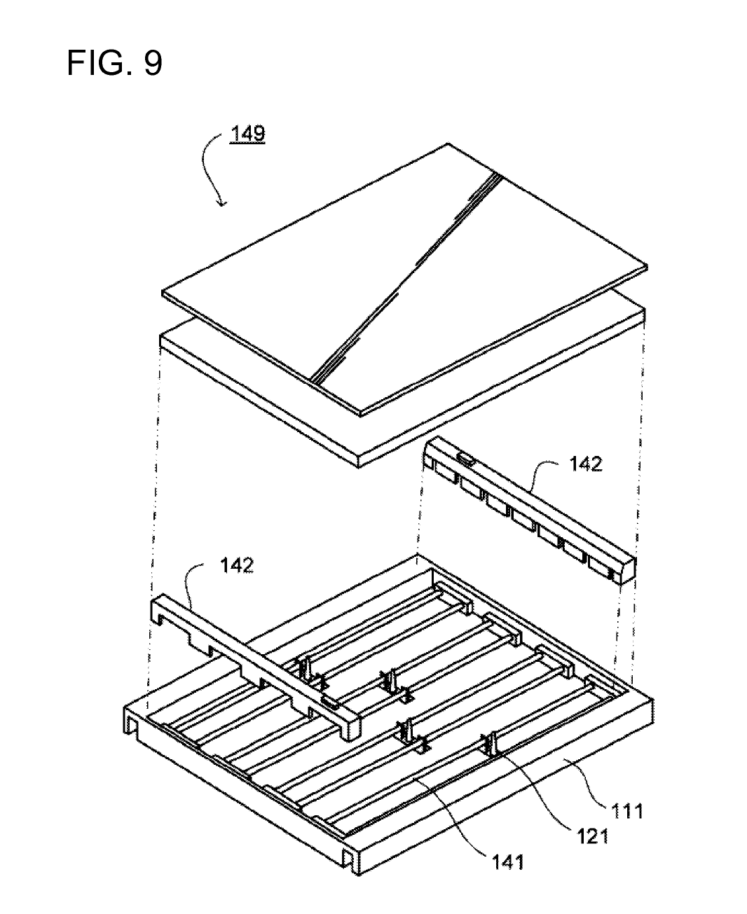

### DETAILED DESCRIPTION OF THE EMBODIMENTS

### Embodiment 1

A description of a first form of embodiment according to the present invention, based on the drawings, is as follows. Note that component numbers, shading, and the like, may be omitted for convenience, and in such cases the other drawings should be referenced.

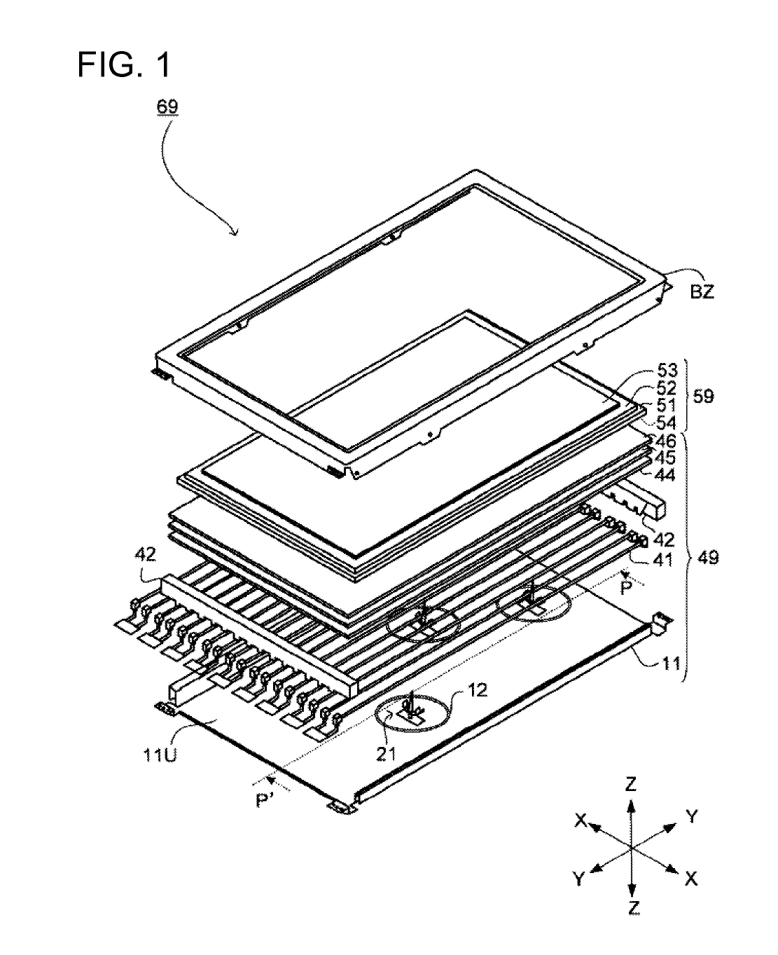

FIG. 1 is an assembly perspective diagram of a liquid crystal display device (display device) 69. As shown in this figure, the liquid crystal display device 69 includes a liquid crystal display panel (display panel) 59, a backlight unit (lighting device) 49, and a bezel BZ containing them.

The liquid crystal display panel 59 includes an active matrix substrate 51, an opposite substrate 52, polarizing films 53 and 54, and a panel FPC (flexible printed circuit) board PB1.

Describing in detail, in the liquid crystal display panel 59, an active matrix substrate 51 that includes switching elements such as TFTs (thin-film transistors) and an opposite substrate 52, which opposes the active matrix substrate 51, are bonded together using a sealing material (not shown). After this, the gap between the two substrates 51 and 52 is filled with liquid crystal (not shown). The polarizing film 53 is adhered to the active matrix substrate 51 side, the polarizing film 54 is adhered to the opposite substrate 52 side so that the active matrix substrate 51 and the opposite substrate 52 are held between the two polarizing films 53 and 54.

Additionally, the liquid crystal display panel 59 is a display panel of a type that does not emit light, so the display function is exhibited through receiving the light from the backlight unit 49 (the backlight). Because of this, if the light from the backlight unit 49 illuminates the entire surface of the liquid crystal display panel 59 uniformly, then the display quality of the liquid crystal display panel 59 will be improved.

The backlight 49 includes: a fluorescent tube (light source) 41, a lamp holder 42, a heat lamp clip 21, a backlight chassis 11, and a group of optical sheets (a diffusion sheet 44 and prism sheets 45 and 46).

The fluorescent tube 41 is a light source of a linear shape (a rod shape, a cylindrical shape, or the like), and a plurality thereof are arranged in a line in the backlight unit 49. (Note that, for convenience, only some of the fluorescent tubes 41 are shown.) Note that the fluorescent tubes 41 are not limited to this type, but may also be, for example, cold cathode tubes or hot cathode tubes. Moreover, below, the direction in which the fluorescent tubes 41 are arranged in parallel (the direction in which the fluorescent tubes 41 are arranged in a line) is termed the X direction, the direction in which a fluorescent tube 41 extends is termed the Y direction, and the direction that is perpendicular to both the X direction and the Y direction is termed the Z direction.

The lamp holders 42 are block-shaped members with two members in one group, and support the fluorescent tubes 42, the diffusion sheet 44, and the prism sheets 45 and 46. Describing in detail, each lamp holder 42 supports one end and the other end of a fluorescent tube 42, to mount the fluorescent tube 42 in the backlight unit 49. Additionally, one face of the lamp holder 42 that faces the liquid crystal display panel 59 supports the diffusion sheet 44, and the prism sheets 45 and 46 are placed thereon to mount this diffusion sheet 44 and prism sheets 45 and 46 in the backlight unit 49.

The lamp clip 21 grips the fluorescent tube 41 in order to mount the fluorescent tube 41 in the backlight unit 49 with greater stability, and is attached to a hole (attaching portion) HL that is formed in the chassis face (the inner face) 11U of the backlight chassis 11. Note that FIG. 1 shows only some of the plurality of lamp clips 21 for convenience. The detail of the lamp clips 21 will be described below.

The backlight chassis 11 is a box-shaped member having an open face, and is formed of metal or the like having a reflective function. The fluorescent tubes 41 are laid and packed within the inner surface of the box shape. Therefore, a portion of the radiant light that is emitted from the fluorescent tube 41 (radiant light centered on the fluorescent tube 41) is reflected and directed to the open face.

Note that if the structural material of the backlight chassis 11 is not made of metal that has a reflective function, then preferably a resin or a metal, or the like, that has a reflective function is coated onto the chassis face 11U. This is because doing so causes the light from the fluorescent tube 41 to be directed efficiently to the open face of the backlight chassis 1.

The diffusion sheet 44 is formed from a resin, such as polyethylene terephthalate, that has a light scattering function and diffusing function, and is positioned to cover the parallel arrangement of fluorescent tubes 41. Because of this, when the light that propagates from the fluorescent tubes 41 is incident on the diffusion sheet 44, the light is scattered and diffused across in the direction within the plane.

The prism sheets 45 and 46 have prism shapes within the sheet faces, for example, and are optical sheets for polarizing the radiant properties of the light. They are positioned to cover the diffusion sheet 44. Because of this, the prism sheets 45 and 46 focus the light that propagates from the diffusion sheet 44 to increase the intensity.

Based on the above, in the backlight unit 49, a backlight chassis 11, a group of fluorescent tubes 41 that are arranged in parallel in the chassis face 11U of the backlight chassis 11, a diffusion sheet 44, and optical sheets 45 and 46 are stacked in that sequence. (Note that the direction of stacking is the Z direction.)

In the backlight unit 49 as described above, the fluorescent tubes 41 that are arranged in parallel on the backlight chassis 11 via the lamp clips 21 emit light through the AC signal that is supplied from an inverter (not shown).

This light arrives at the diffusion sheet 44 directly, or arrives at the diffusion sheet 44 after being reflected from the chassis surface (the reflecting face) of the backlight chassis 11. Following this, the light that has arrived at the diffusion sheet 44 is diffused and passes through the sheets 45 and 46, to be emitted as light from a backlight with increased light-emission intensity.

When the fluorescent tube 41 that emits light through the AC signal from the inverter is positioned over the chassis face 11U of the backlight chassis 11, which is made of metal and is a conductor, a parasitic capacitance is produced between the fluorescent tube 41 and the backlight chassis 11, caused by the lighting control AC signal (the lighting control signal) that is included in the AC signal from the inverter. An electromagnetic force that is caused by the parasitic capacitance vibrates the fluorescent tube 41.

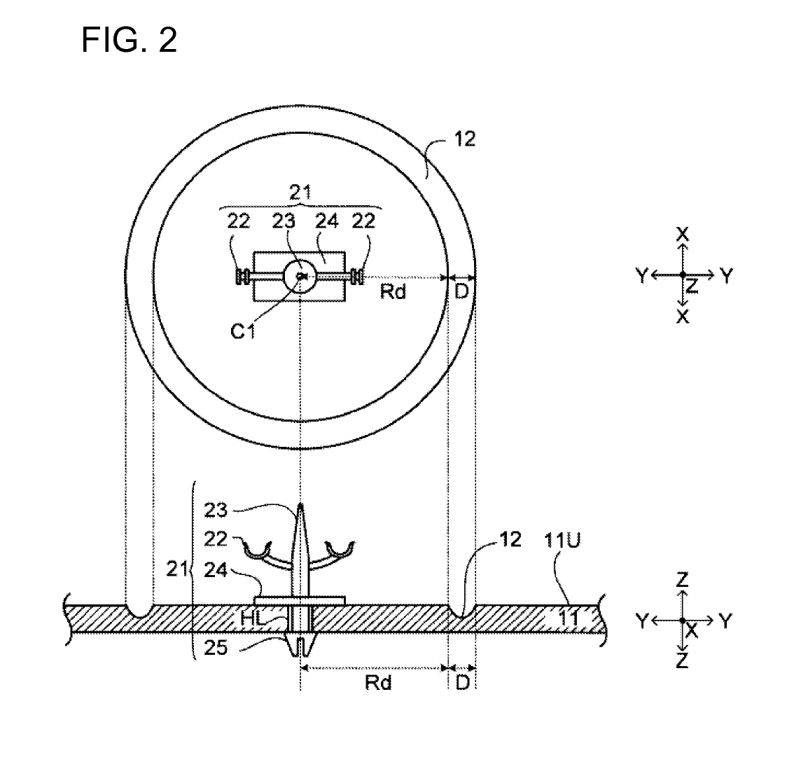

The lamp clips 21 that hold the vibrating fluorescent tube 41 and the backlight chassis 11 in which the lamp clips 21 are attached to the holes HL will be described in detail with reference to FIGS. 2 to 6 in addition to FIG. 1.

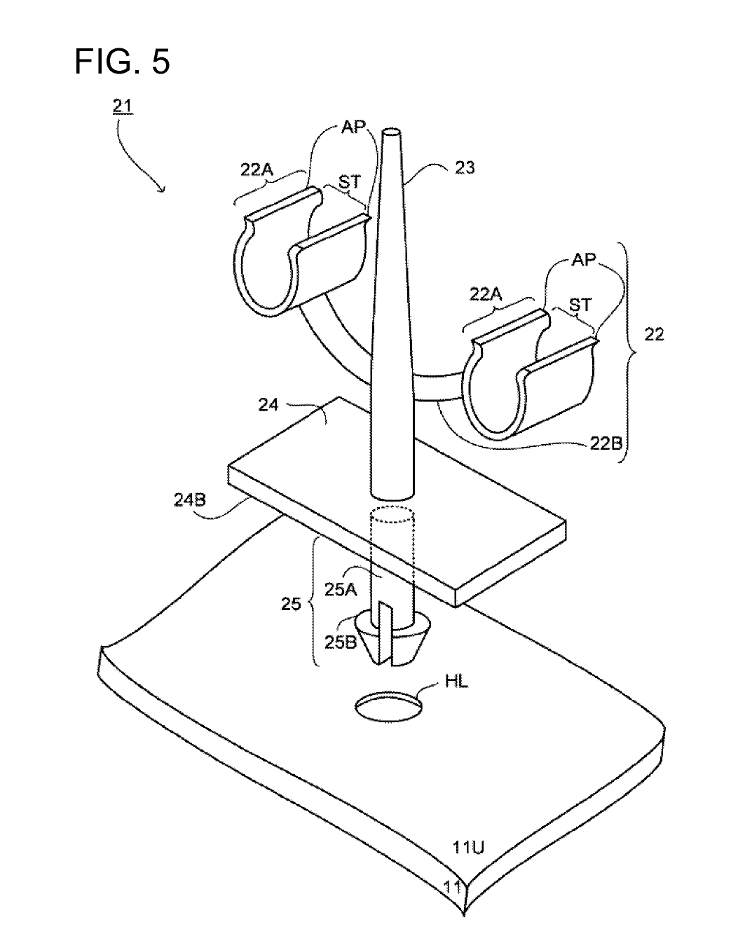

First, a lamp clip 21 will be described in detail using FIG. 5. The lamp clip 21 includes a holding portion 22, a support column portion 23, a base portion 24, and a mating portion 25.

The holding portion 22 is a member that holds the fluorescent tube 41, and specifically, includes gripping pieces 22A and 22A, and a branch piece 22B.

The gripping piece 22A is a member that grips the side surface of the rod-shaped (cylindrically shaped, etc.) fluorescent tube 41. Because of this, the gripping piece 22A has a cylindrical tube shape that is provided with a cutout ST on the side surface in order to grip the fluorescent tube 41 that has a cylindrical shape or the like. Note that the gripping piece 22A, in order to grip the fluorescent tube 41, has an inner diameter for the gripping piece 22A that is slightly larger than the outer diameter of the fluorescent tube 41.

Moreover, the material of the gripping piece 22A is non-metallic, such as, for example, resin. The reason for this is that the gripping pieces 22A and 22A contact the fluorescent tube 41 directly, so if they were metal, the AC signal that is supplied in order to actuate the fluorescent tube 41 would leak (if the signal were to leak it would reduce the intensity of the light at that spot).

Additionally, the gripping piece 22A includes extension parts AP and AP that are the edge parts of the cutaway ST. These extension parts AP and AP widen further from the inner radial center of the gripping piece 22A. Because of this, the gap of the cutaway ST (between the extension parts AP and AP) widens further from the radial center of the gripping piece 22A.

In addition, these extension parts AP and AP have elasticity because they are made of resin. Given this, when the fluorescent tube 41 is aligned with the cutaway ST and pressed, the extension parts AP and AP move apart from each other due to the elasticity. The result is that the fluorescent tube 41 is fitted easily into the interior of the gripping piece 22A.

After the fluorescent tube 41 has been fitted into the gripping piece 22A, the extension parts AP and AP, wherein the gap of the cutaway ST was increased, returns to the original shape (the normal shape that does not pinch the fluorescent tube 41) due to their elasticity. At this point, the extension parts AP and AP approach each other and press on the fluorescent tube 41. The result is that the fluorescent tube 41 will not fall out from the gripping piece 22A, and is gripped stably.

The branch piece 22B is a member for connecting together the gripping pieces 22A and 22A. Note that there is no particular limitation on the shape of the branch piece 22B. For example, it may be a member that is curved in an arc, such as illustrated in FIG. 5, or may be a V-shaped member. Basically, the branch piece 22B should be formed so as to be able to connect together the gripping pieces 22A and 22A.

Note that there is no particular limitation on the material for the branch piece 22B either. Consequently, the material may be metal, or the material may be resin. Basically, the branch piece 22B should have strength so as to be able to support the gripping pieces 22A and 22A.

The support column portion 23 is a member that supports the holding portion 22. Describing in detail, the support column portion 23 is connected to the branch piece 22B in order to support the holding portion 22. Note that there is no particular limitation on the shape of the support column portion 23. For example, it may be a support column portion 23 of a circular column shape or a polygonal shape. Note that the tip end of the support column portion 23 contacts the diffusion sheet 44, to support not only the diffusion sheet 44 but also the prism sheets 45 and 46.

Moreover, there is no particular limitation on the material of the support column portion 23 either. The material may be metal or may be resin. Basically, the support column portion 23 should have strength sufficient to support the set of optical sheets (44 through 46) on the tip end thereof, and so as to be able to support the fluorescent tubes 41 through the holding portion 22.

The base portion 24 is formed at the end of the support column portion 23, and is a member for supporting the support column portion 23. Moreover, in the base portion 24, a back face 24B (the face that forms the mating portion 25) is contacted to the chassis face 11U of the backlight chassis 11 to cause the support column portion 23 to stand erect relative to the backlight chassis 11.

Because of this, preferably, the back face 24B of the base portion 24 is a shape that has a high degree of conformity with the chassis face 11U so as to cause the support column portion 23 to stand erect with stability. For example, if the chassis face 11U is flat, then preferably, the back face 24B of the base portion 24 is also flat.

The mating portion 25 is a member for connecting to the back face 24B of the base portion 24, a member for attaching the lamp clip 21 itself to the chassis face 11U of the backlight chassis 11. Specifically, the mating portion 25 includes a protruding piece 25A and a catch piece 25B.

The protruding piece 25A is a column piece (where the shape of the column may be a circular column or a polygonal column) having an outer diameter that is slightly smaller than the diameter of the hole HL that is formed in the backlight chassis 11, and protrudes from the back face 24B of the base portion 24. Moreover, the lamp clip 21 is made immovable, in the direction within the plane of the chassis face 11U, through insertion of the protruding piece 25A into the hole HL.

The catch piece 25B is formed on the tip end of the protruding piece 25A, and is a member for catching on the edge of the hole HL in the backlight chassis 11. Consequently, the lamp clip 21 is made immovable in the standing direction (the perpendicular direction or the like) relative to the chassis face 11U of the backlight chassis 11 through the catch piece 25B catching on the edge of the hole HL.

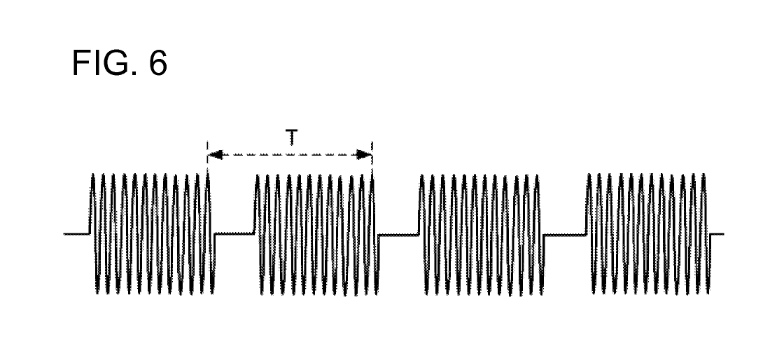

Here the fluorescent tube 41 that is mounted on the backlight chassis 11 through being held by the lamp clip 21 will be described in detail. Normally, the vibration of the fluorescent tube 41 is caused by the phenomena described below based on the ON signal of the lighting control signal, as illustrated in FIG. 6, and the phenomena described below based on the OFF signal of the lighting control signal. (Note that in the diagram, the “T” indicates one period of the fundamental wave of the lighting control signal.)

That is, the fluorescent tube 41 is vibrated by the phenomenon in which the fluorescent tube 41 approaches the backlight chassis 11 due to the electromagnetic force based on the parasitic capacitance that is produced between the fluorescent tube 41 and the backlight chassis 11 through the ON signal of the lighting control signal, and the phenomenon of the fluorescent tube 41 attempting to return to the original position through the parasitic capacitance (and thus by the electromagnetic force) vanishing due to the OFF signal of the lighting control signal. Further, this vibration of the fluorescent tube 41 propagates also to the backlight chassis 11 through the lamp clip 21 that is fitted in the hole HL (where fundamentally the vibration of the fluorescent tube 41 is propagated from the hole HL), vibrating the backlight chassis 11.

However, as illustrated in FIG. 1 and FIG. 2 (two figures that show a cross-sectional diagram when viewed in the direction of the arrow P-P′ in FIG. 1 together with a plan view), the backlight chassis 11 includes an annular groove portion (surrounding portion) 12 that surrounds the hole HL into which the lamp clip 21 is fitted.

When formed in this way, even if the fluorescent tube 41 vibrates and the wave of that vibration propagates to the backlight chassis 11 through the lamp clip 21 that is fitted in the hole HL, it does not propagate across the entire backlight chassis 11. (Basically, the groove portion 12 absorbs the vibration that propagates to the backlight chassis 11 from the lamp clip 21 that is fitted in the hole HL.) The result is that the noise that is caused by the vibration of the backlight chassis 11 is reduced.

Here, the groove portion 12 may be formed as described below. That is, Equation (1) and Equation (2) may be defined as shown below, and the shape of the groove portion 12 may be varied using these equations.

D=Rd×1/(f×n) Equation (1)

wherein:

D is the amount of the width of the groove portion 12 at the chassis face 11U of the backlight chassis 11 (the groove width D);

Rd is the shortest distance from the lamp clip 21 (the center C1) to the groove portion 12 (distance Rd);

f is the frequency of the fundamental wave in the lighting control signal; and

n is the order of the harmonic wave (where n=1).

rd=D/2 Equation (2)

wherein:

rd is the radius of a curved surface included in the inner surface A of the groove portion 12 (for example, of curved surfaces A1 through A5) (radius rd); and

D is the amount of the width of the groove portion 12 at the chassis face 11U of the backlight chassis 11. (Note that a plurality of values for the groove width D, calculated by varying the order n (n=1, 2, 3, . . . ) in Equation (1) are used.)

Specifically, first, as illustrated in FIG. 2, a position for forming the groove portion 12 is established at a location that is separated by a specific distance (distance Rd) from the lamp clip 21 (the center C1). For example, suppose that the groove portion 12 is to be formed at a position that is 0.04 m away from the lamp clip 21. Then, if the lighting control signal has a frequency of 100 Hz, according to Equation (1), the 0.04 m is multiplied by a factor of ( 1/100×1), so the groove width D will be 4×10⁻⁴ m.

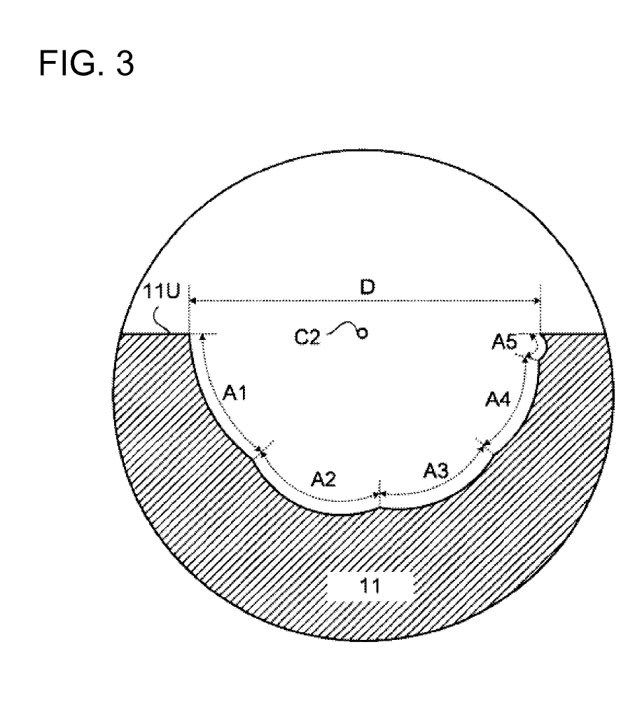

Then, as shown in reference to FIG. 3, the inner face A of the groove portion 12 is formed of a collection of a plurality of different curved surfaces (for example, curved surfaces A1 through A5). The respective curved surfaces A1, A2, A3, A4, and A5 are curved surfaces based on the radius rd that is calculated from Equation (2) with the groove width D for the cases where the orders n in Equation (1) are n=1, 2, 3, 4, and 5.

That is, when the groove width D is determined from the distance Rd from the lamp clip 21 and the frequency of the fundamental wave in the lighting control signal (using a harmonic order n of 1), the inner surfaces A of the groove portion 12 include shapes corresponding to the harmonics of the lighting control signal. Note that the examples of embodiment for specific values for the radius rd that defines the shapes of the inner surfaces A1 through A5 are as follows (these are the case of the distance Rd=0.04 m):

Curved surface A1: radius rd1=4/1/2×10⁻⁴ m

Curved surface A2: radius rd2=4/2/2×10⁻⁴ m

Curved surface A3: radius rd3=4/3/2×10⁻⁴ m

Curved surface A4: radius rd4=4/4/2×10⁻⁴ m

Curved surface A5: radius rd5=4/5/2×10⁻⁴ m

As described above, if the inner surface A in the groove portion 12 is formed as a collection of a plurality of different curved surfaces (for example, curved surfaces A1 through A5), then the following can be said. For example, if the lighting control signal contains only the fundamental wave, then there would be no problem if the inner surface A of the groove portion 12 included only the curved surface A1 based on the groove width D and the diameter rd that is calculated from the groove width D. However, the brightness of the fluorescent tube 41 is controlled through PWM (pulse width modulation).

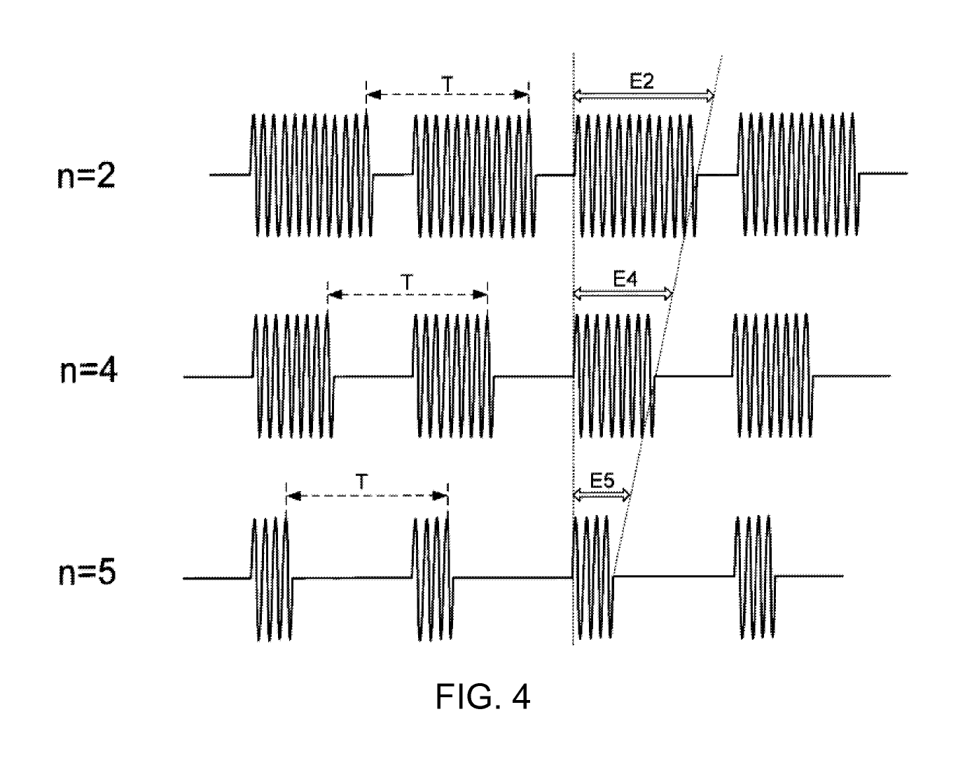

Because of this, when such lighting control is performed, then, as illustrated in FIG. 4, the energy that is propagated to the backlight chassis 11 will also vary, and, as a result, harmonic waves of constant multiples relative to the fundamental wave of the lighting control signal will propagate to the backlight chassis 11 as vibrations (the vibration energy E per unit time for the lighting control signal with orders n=1, 2, 3, . . . is defined as E1, E2, E3, . . . , as illustrated in FIG. 4, then the magnitude relationship of the vibration energy E will be inversely proportional to the order (E1>E2>E3> . . . )).

However, when curved surfaces corresponding to the respective harmonic waves relating to the fundamental wave of the lighting control signal (for example, curved surface A2 through curved surface A5) are included in the inner surface A of the groove portion 12 in addition to the curved surface A1, then even if there are vibrations at harmonics of the various orders n and even if they propagate to the backlight chassis 11, the groove portion 12 will be able to sufficiently absorb the different vibrations. That is, even if the fluorescent tube 41 were to vibrate and the wave of that vibration were to propagate to the backlight chassis 11 through the lamp clip 21 that is fitted in the hole HL, the wave of the vibration would not spread to the entirety of the backlight chassis 11 with certainty.

### Other Forms of Embodiments

The present invention is not limited to the forms of embodiment set forth above, but rather can be modified in a variety of ways within a scope that does not deviate from the spirit or intent of the present invention.

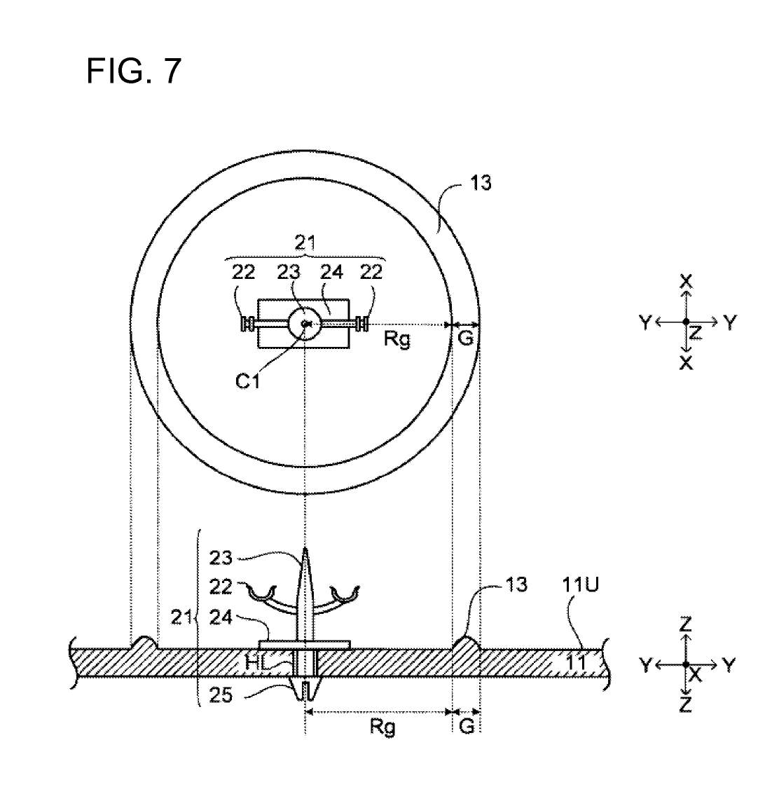

For example, while the groove portion 12 that is engraved in the backlight chassis 11 stops the spread (propagation) of the vibration from the lamp clip 21 that is fitted in the hole HL above, the present invention is not limited to this. For example, as illustrated in the double drawing in FIG. 7 (the plan view and the cross-sectional diagram), a ridge portion 13 that is built up from the chassis face 11U of the backlight chassis 11 may be formed, surrounding the lamp clip 21 (or in other words, surrounding the hole HL).

Even when formed in this way, the annular ridge portion (surrounding portion) 13 that surrounds the lamp clip 21 will not allow the wave of the vibration that is propagated to the backlight chassis 11 through the lamp clip 21 that is fitted into the hole HL to spread to the entirety of the backlight chassis 11. In other words, the ridge portion 13 absorbs the vibration.

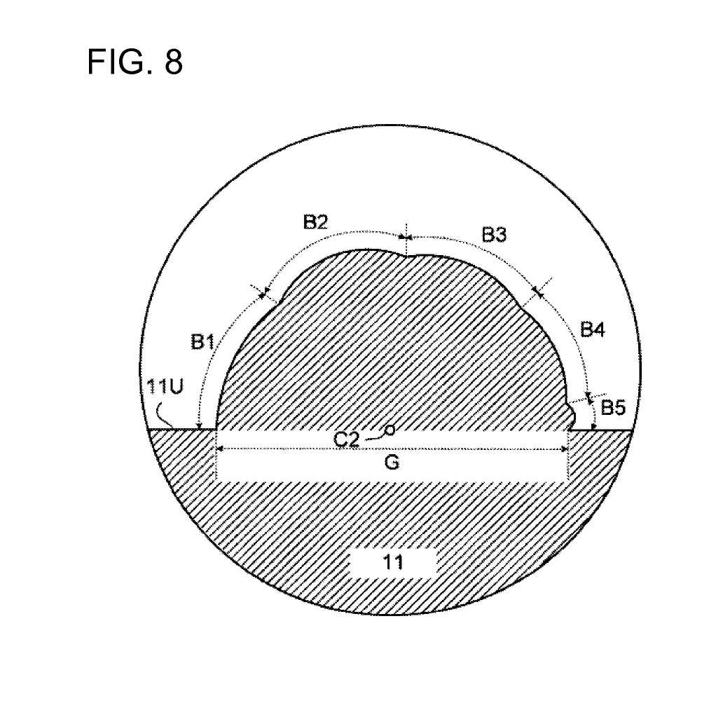

Moreover, as illustrated in FIG. 8, the outer surface B of the ridge portion 13 that is formed on the backlight chassis 11 may be formed as a collection of a plurality of different curved surfaces (for example, curved surfaces B1 through B5).

The curved surfaces B1 through B5 are calculated in a manner similar to the curved surfaces A1 through A5. Describing in detail, the following Equation (3) and Equation (4), which resemble Equation (1) and Equation (2) are used to design the curved surfaces B1 through B5. (See FIG. 7 and FIG. 8.)

G=Rg×1/(f×n) Equation (3)

wherein:

G is the amount of the width of the ridge portion 13 at the chassis face 11U of the backlight chassis 11 (the ridge width G);

Rg is the shortest distance from the lamp clip 21 (the center C1) to the ridge portion 13 (distance Rg);

f is the frequency of the fundamental wave in the lighting control signal; and

n is the order of the harmonic wave (where n=1).

rg=G/2 Equation (4)

wherein:

rg is the radius of a curved surface included in the outer surface B of the ridge portion 13 (for example, curved surfaces B1 through B5) (radius rg); and

G is the amount of the width of the ridge portion 13 at the chassis face 11U of the backlight chassis 11. (Note that a plurality of values for the groove width G, calculated by varying the order n (n=1, 2, 3, . . . ) in Equation (3) are used.)

Specifically, the position for forming the ridge portion 13 is established in a position that is a specific distance (distance Rg) away from the lamp clip 21 in a manner similar to the case of the groove portion 12. (See FIG. 7.) Following this, as illustrated in FIG. 8, the outer surface B of the ridge portion 13 is formed as a collection of a plurality of different curved surfaces (for example, curved surfaces B1 through B5). The individual curved surfaces B1, B2, B3, B4, and B5 are curved surfaces based on the radii rg that are calculated from Equation (4) at the ridge width G for the cases of the orders in Equation (3) being n=1, 2, 3, 4, and 5.

As described above, the outer surface B of the ridge portion 13 formed as a collection of a plurality of different curved surfaces makes it possible to obtain the same effect as that of the groove portion 12 that is formed as a collection of a plurality of different curved surfaces. That is, even if harmonics were to vibrate at various different orders n and propagate to the backlight chassis 11, the ridge portion 13 is able to sufficiently absorb these different vibrations, so that the waves of those vibrations will not spread to the entirety of the backlight chassis 11 with certainty.

### DESCRIPTION OF REFERENCE CHARACTERS

11 backlight chassis (chassis)
HL hole (attaching portion)
11U chassis face
12 groove portion (surrounding portion, groove)
A inner surface of groove portion
13 ridge portion (surrounding portion, ridge)
B outer surface of ridge portion
21 lamp clip (clip)
22 holding portion
20 support column portion
24 base portion
25 mating portion
41 fluorescent tube (light source, linear light source)
42 lamp holder
44 diffusion sheet
45 prism sheet
46 prism sheet
49 backlight unit (lighting device)
59 liquid crystal display panel (display panel)
69 liquid crystal display device (display device)

1. A chassis, comprising an attaching portion for attaching a clip for gripping a light source; and an annular surrounding portion that surrounds the attaching portion for absorbing a vibration from the attaching portion.

2. The chassis as set forth in claim 1, wherein the surrounding portion is a groove that is engraved in a face of the chassis.

3. The chassis as set forth in claim 2, wherein an inner surface of the groove is formed of a collection of a plurality of different curved surfaces.

4. The chassis as set forth in claim 1, wherein the surrounding portion is a ridge that is built up from a face of the chassis.

5. The chassis as set forth in claim 4, wherein an outer surface of the ridge is formed of a collection of a plurality of different curved surfaces.

6. A lighting device comprising:
the chassis as set forth in claim 1;
a linear light source that is said light source; and
said clip for holding the linear light source.

7. A display device comprising:
the lighting device as set forth in claim 6; and
a display panel that receives light from the lighting device.
